(19) United States
(12) Patent Application Publication
(10) Pub. No.: US 2016/0370188 A1
(43) Pub. Date: Dec. 22, 2016

(54) INERTIAL DEVICE, CONTROL METHOD AND PROGRAM

(71) Applicants: Yusuke MATSUSHITA, Kanagawa (JP); Takeo TSUKAMOTO, Kanagawa (JP); Daisuke HATA, Saitama (JP); Fumio YOSHIZAWA, Kanagawa (JP); Keisuke KONISHI, Kanagawa (JP)

(72) Inventors: Yusuke MATSUSHITA, Kanagawa (JP); Takeo TSUKAMOTO, Kanagawa (JP); Daisuke HATA, Saitama (JP); Fumio YOSHIZAWA, Kanagawa (JP); Keisuke KONISHI, Kanagawa (JP)

(73) Assignee: Ricoh Company, Ltd., Tokyo (JP)

(21) Appl. No.: 15/118,922

(22) PCT Filed: Feb. 17, 2015
(86) PCT No.: PCT/JP2015/054903

§ 371 Date: Aug. 15, 2016

(30) Foreign Application Priority Data
Feb. 19, 2014 (JP) 2014-029490

(51) Int. Cl. G01C 21/20

(52) U.S. Cl. CPC G01C 21/206

(57) ABSTRACT

An inertial device for, by using azimuth data indicating a direction of travel calculated based on an acceleration of a moving user, calculating coordinate data indicating a position of the user, includes an azimuth drift calculation unit configured to determine whether a moving direction, which is specified based on the coordinate data calculated while the user makes a predetermined amount of movement, of the predetermined amount of movement of the user satisfies a condition defined in direction adjusting condition information with respect to a predetermined reference direction, and an adjusting unit configured to, in response to the determination by the azimuth drift calculation unit that the predetermined condition is satisfied, adjust the acceleration, which is newly obtained to calculate new coordinate data, based on a difference between the direction of travel indicated by the azimuth data which have already been calculated and the reference direction.

### TECHNICAL FIELD

The present invention generally relates to an inertial device, a control method and a program.

### BACKGROUND ART

In an environment such as indoor, a basement or the like, where it is difficult to use a GPS (Global Positioning System) receiver, conventionally, applications of a Pedestrian Dead Reckoning (PDR) technology in which positioning is performed based on detection results of an inertial device have been considered.

The inertial device is a device in which a geomagnetic sensor is integrated with an inertial sensor such as an angular velocity sensor or an acceleration sensor, and calculates azimuth data indicating a direction of travel of a user equipped with the inertial device and positioning data such as coordinate data indicating the position of the inertial device.

Here, the geomagnetic sensor included in the inertial device is susceptible to an influence of disorder of an ambient magnetic field in a room, a basement, etc., of a building with reinforced concrete construction. Therefore, under the influence of disorder of the ambient magnetic field, accuracy of azimuth data calculated based on a detection result of the geomagnetic sensor is lowered and an error of coordinate data calculated by using the azimuth data becomes bigger.

In contrast to this, in Patent Document 1, for example, a configuration is proposed in which, in the case where it is determined that the reliability of the geomagnetic sensor is lowered due to the influence of disorder of the ambient magnetic field, the azimuth data is switched to be calculated based on the angular velocity sensor.

However, in a configuration where a detection result of the angular velocity sensor is used for the calculation of the azimuth data, calculation accuracy of the azimuth data indicating the direction of travel becomes lowered as time passes due to a change of zero point offset, accumulations of noise and integration errors, or the like.

For this reason, when calculating the azimuth data indicating the direction of travel, it is desirable to increase the calculation accuracy by having a configuration in which misalignment of the azimuth data is corrected frequently, thereby the degradation of calculation accuracy which gets worse as time passes can be suppressed.

The present invention has been made in view of the above problems, and it is an object of the present invention to increase calculation accuracy of azimuth data indicating the direction of travel of a user in an inertial device.

### DISCLOSURE OF THE INVENTION

An inertial device according to an embodiment of the present invention includes a following configuration. That is, the inertial device for, by using azimuth indicating a direction of travel calculated based on an acceleration of a moving user, calculating coordinate data indicating a position of the user, includes a determination unit configured to determine whether a moving direction, which is specified based on the coordinate data calculated while the user makes a predetermined amount of movement, of the predetermined amount of movement of the user satisfies a predetermined condition with respect to a predetermined reference direction; and an adjusting unit configured to, in response to determination by the determination unit that the predetermined condition is satisfied, adjust the acceleration, which is newly obtained to calculate new coordinate data, based on a difference between the direction of travel indicated by the azimuth data which have already been calculated and the reference direction.

### BRIEF DESCRIPTION OF THE DRAWINGS

FIG. 1 is a drawing illustrating an overall configuration of a positioning system including an inertial device according to an embodiment of the present invention.

FIG. 2 is a drawing illustrating a hardware configuration of a positioning server apparatus included in a positioning system.

FIGS. 3A and 3B are drawings describing an example of a process performed by a positioning server apparatus.

FIG. 4 is a drawing illustrating a hardware configuration of an inertial device according to an embodiment of the present invention.

FIG. 5 is a drawing illustrating a functional configuration of a positioning unit of an inertial device.

FIG. 6 is a drawing illustrating a functional configuration of a direction-of-travel estimation unit included in a positioning unit.

FIG. 7 is a drawing illustrating a functional configuration of a position estimation unit included in a positioning unit.

FIG. 8 is a flowchart illustrating a flow of direction-of-travel and position estimation process by a direction-of-travel estimation unit and a position estimation unit.

FIG. 9 is a drawing illustrating an example of direction adjusting condition information.

FIGS. 10A and 10B are drawings describing an overview of a process of a moving state detection unit included in an azimuth drift estimation processing unit included in a positioning unit.

FIG. 11 is a drawing illustrating an aspect of comparing a moving state reported by a moving state detection unit with direction adjusting condition information.

FIG. 12 is a drawing describing a method for calculating a direction error estimate value by a direction drift calculation unit included in an azimuth drift estimation processing unit included in a positioning unit.

FIG. 13 is a flowchart illustrating a flow of a direction error estimation process in an azimuth drift estimation processing unit.

FIG. 14 is a drawing illustrating a functional configuration of an attitude information conversion processing unit included in a positioning unit.

FIG. 15 is a flowchart illustrating a flow of an attitude information conversion process by an attitude information conversion processing unit. FIG. 16 is a control block diagram implementing a process for correcting misalignment of azimuth data performed by a positioning unit.

FIG. 17 is a drawing describing an example of a process performed by a positioning server apparatus.

FIGS. 18A and 18B are drawings illustrating a relation between a direction of travel and azimuth data in an absolute coordinate system and a relation between coordinate data and a moving direction.

### MODE FOR CARRYING OUT THE INVENTION

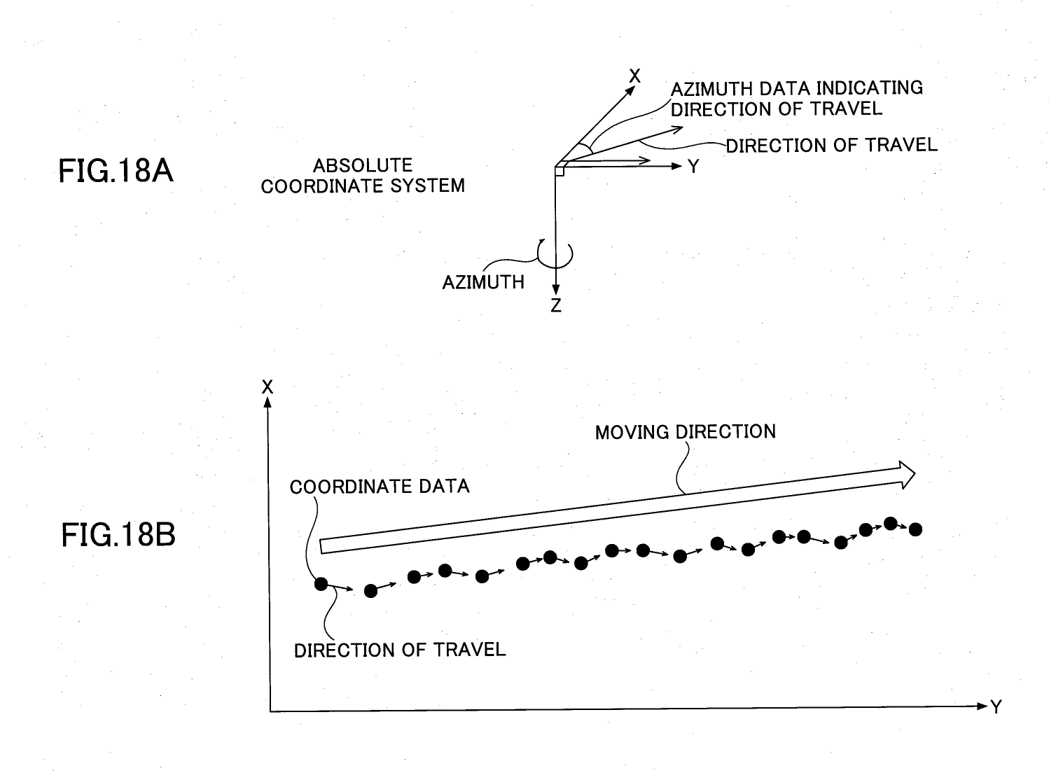

In the following, embodiments of the present invention will be described with reference to the accompanying drawings. First, before starting embodiment description, definitions of terms used in the description will be described referring to FIGS. 18A and 18B.

FIG. 18A is a drawing illustrating a relation between a direction of travel and azimuth data in an absolute coordinate system. An “absolute coordinate system” is a unifying coordinate system used for handling, in a unifying way, coordinate data calculated by detection results of a plurality of kinds of sensors described below. An “absolute coordinate system” includes, for example, a WGS84 longitude and latitude coordinate system used in GPS and a Cartesian coordinate system such as a UTM (Universal Transverse Mercator). In other words, an “absolute coordinate system” is a coordinate system in which a unique origin fixed in a predetermined space is defined, and a position or a direction of travel of a target object (in the following embodiments, a user wearing an inertial device) can be expressed using a distance relation from the origin.

Also, as shown in FIG. 18A, “directions of travel” are directions of acceleration in an X-Y plane of an absolute coordinate system, which directions are calculated from detection results of a sensor, and each of which directions indicates a direction a user faces at a corresponding time while the user is moving.

It should be noted that an angle around the Z-axis of an absolute coordinate system is referred to “azimuth”, and as shown in FIG. 18A, an angle formed by a direction of travel and an X-axis is referred to as “azimuth data”. That is, a “direction of travel” can be expressed by “azimuth data”.

FIG. 18B is a drawing illustrating a relation between coordinate data and a moving direction. “Coordinate data” are data for indicating positions of a user in an absolute coordinate system, each of which can be calculated based on azimuth data indicating a direction of travel at a corresponding time while the user is moving.

Also, a “moving direction” refers to a direction in a predetermined section while the user is moving on foot. As shown in FIG. 18B, the “moving direction” can be calculated based on coordinate data calculated while the user moves a predetermined distance.

Based on the above definitions, in the following, embodiments of the present invention will be described in detail. It should be noted that in the specification and the drawings, configuration elements which include substantially the same functional configuration are given the same reference numeral in order to avoid duplicated descriptions.

### First Embodiment

### 1. OVERALL CONFIGURATION OF A POSITIONING SYSTEM

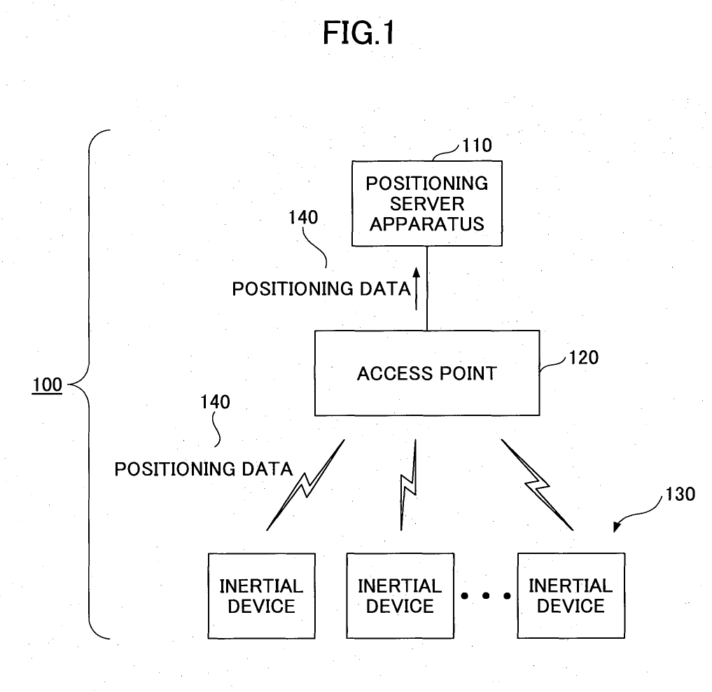

First, an overall configuration of a positioning system including an inertial device according to an embodiment of the present invention will be described. FIG. 1 is a drawing illustrating an overall configuration of a positioning system 100 including an inertial device according to an embodiment of the present invention.

As shown in FIG. 1, the positioning system 100 includes a positioning server apparatus 110 and an access point 120 connected to the positioning server apparatus 110, and a plurality of inertial devices 130 are wirelessly and communicatively connected to the access point 120.

The positioning server apparatus 110 receives positioning data 140 (here, coordinate data indicating users' positions) transmitted from the inertial devices 130 attached to users, and performs a predetermined process for the received positioning data 140.

The access point 120 is an apparatus for wirelessly communicating with the inertial devices 130. In an example of FIG. 1, only one access point 120 is shown, but there may be a plurality of the access points 120.

The inertial devices 130 are worn by respective users and calculate azimuth data indicating users' directions of travel and coordinate data indicating users' positions at a predetermined cycle (e.g., one second cycle) based on detection results output from built-in sensors (sensors for detecting users' moving state). Also, the inertial devices 130 transmit the calculated coordinate data as the positioning data 140 to the positioning server apparatus 110 via the access point 120 at a predetermined cycle (e.g., one second cycle).

### 2. CONFIGURATION OF POSITIONING SERVER APPARATUS

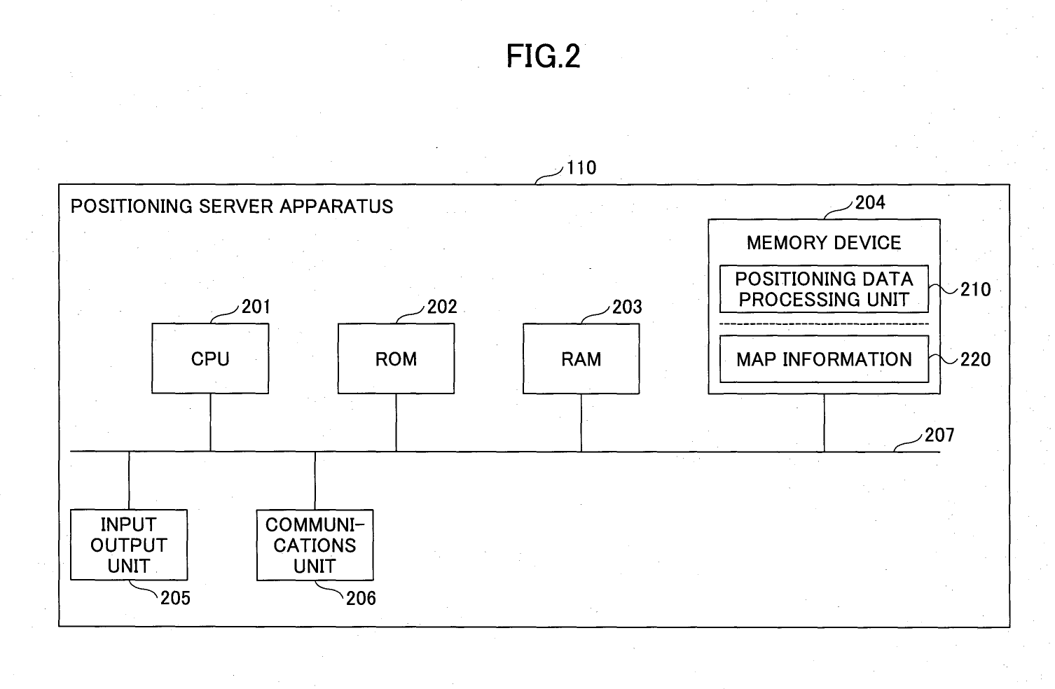

Next, a configuration of the positioning server apparatus 110 included in the positioning system 100 will be described. FIG. 2 is a drawing illustrating a hardware configuration of the positioning server apparatus 110.

As shown in FIG. 2, the positioning server apparatus 110 includes a CPU (Central Processing Unit) 201, a ROM (Read Only Memory) 202, and a RAM (Random Access Memory) 203. Furthermore, the positioning server apparatus 100 includes a memory device 204, an input/output unit 205 and a communications unit 206. It should be noted that units of the positioning server apparatus 110 are connected to each other via a bus 207.

The CPU 201 is a processor for executing a program which is stored in the memory device 204, and functions as a positioning data processing unit 210. By causing the CPU 201 to execute the program functioning as the positioning data processing unit 210, the positioning server apparatus 110 can display a moving trajectory of a user, which is calculated based on the positioning data 140, superimposed on map information 220.

The ROM 202 is a non-volatile memory. The ROM 202 stores various kinds of programs, data and the like which are needed for the CPU 201 to execute a program stored in the memory device 204. Specifically, the ROM 202 stores a BIOS (Basic Input/Output System), a boot program including an EFI (Extensible Firmware Interface), and the like.

The RAM 203 is a main memory device including a DRAM (Dynamic Random Access Memory), an SRAM (Static Random Access Memory), or the like. The RAM 203 functions as a work area in which a program stored in the memory device 204 is read/written when the CPU 201 executes the program.

The memory device 204 stores a program which causes the CPU 201 to function as the positioning data processing unit 210. Also, the memory device 204 stores the map information 220 used by a process of the positioning data processing unit 210.

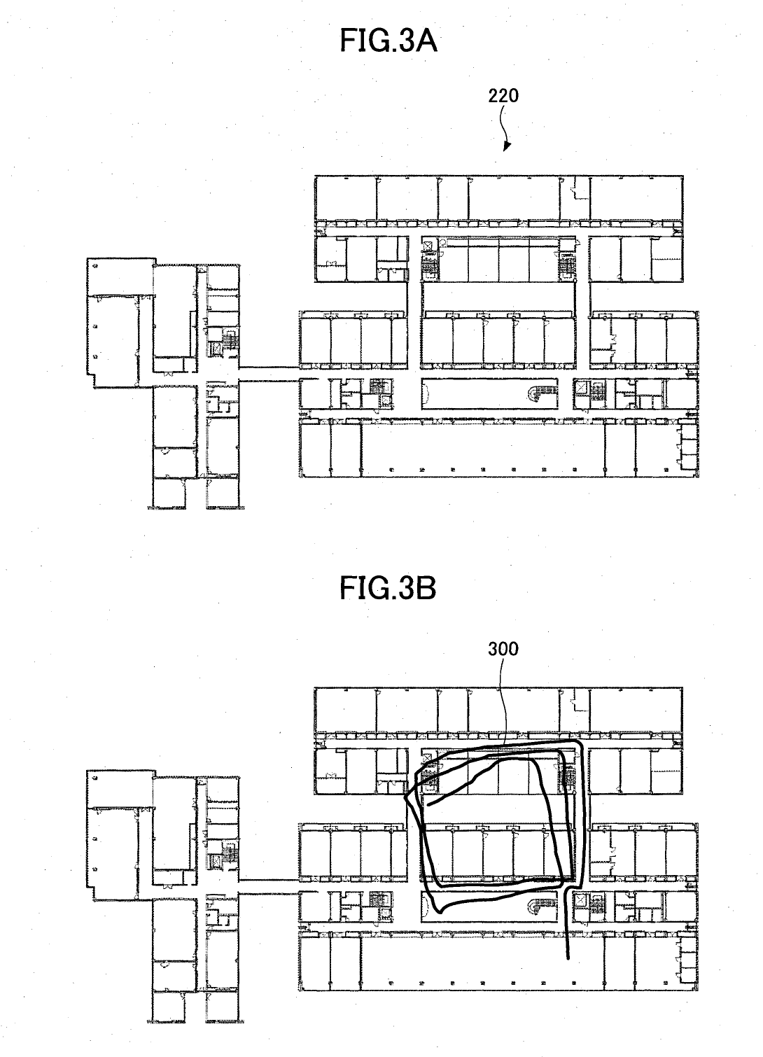

The map information 220 is information indicating a layout inside a building including an office where users wearing the inertial devices 130 exist. Details of the map information 220 will be described later referring to FIG. 3.

The input/output unit 205 is used for inputting various kinds of instructions for the positioning server apparatus 110, or for displaying an internal state of the positioning server apparatus 110.

The communications unit 206 receives the positioning data 140 from the inertial devices 130 at a predetermined cycle (e.g., one second cycle).

### 3. PROCESS EXECUTED BY POSITIONING SERVER APPARATUS

Next, a process performed by the positioning server apparatus 110 will be described. FIGS. 3A and 3B are drawings describing an example of a process performed by the positioning server apparatus 110.

FIG. 3A is an example of the map information 220 used when the process is performed by the positioning server apparatus 110, and illustrates a layout in a building including an office where users wearing the inertial devices 130 exist.

FIG. 3B illustrates an aspect in which a moving trajectory 300 of a user wearing the inertial device 130 for a predetermined period is displayed superimposed on the map information 220, which moving trajectory 300 is calculated by using the positioning data 140 transmitted by the inertial device 130.

In this way, by displaying the positioning data 140 transmitted from the inertial device 130 superimposed on the map information 220, the positioning server apparatus 110 can obtain a current position, a moving record, and the like, of a user in an office.

It should be noted that the moving trajectory shown in FIG. 3B is a trajectory generated based on the coordinate data calculated without performing a process for correcting misalignment of the azimuth data (details of the process will be described later). Because of the lack of the process, it can be seen that the error of the coordinate data becomes bigger as time passes.

### 4. CONFIGURATION OF INERTIAL DEVICE

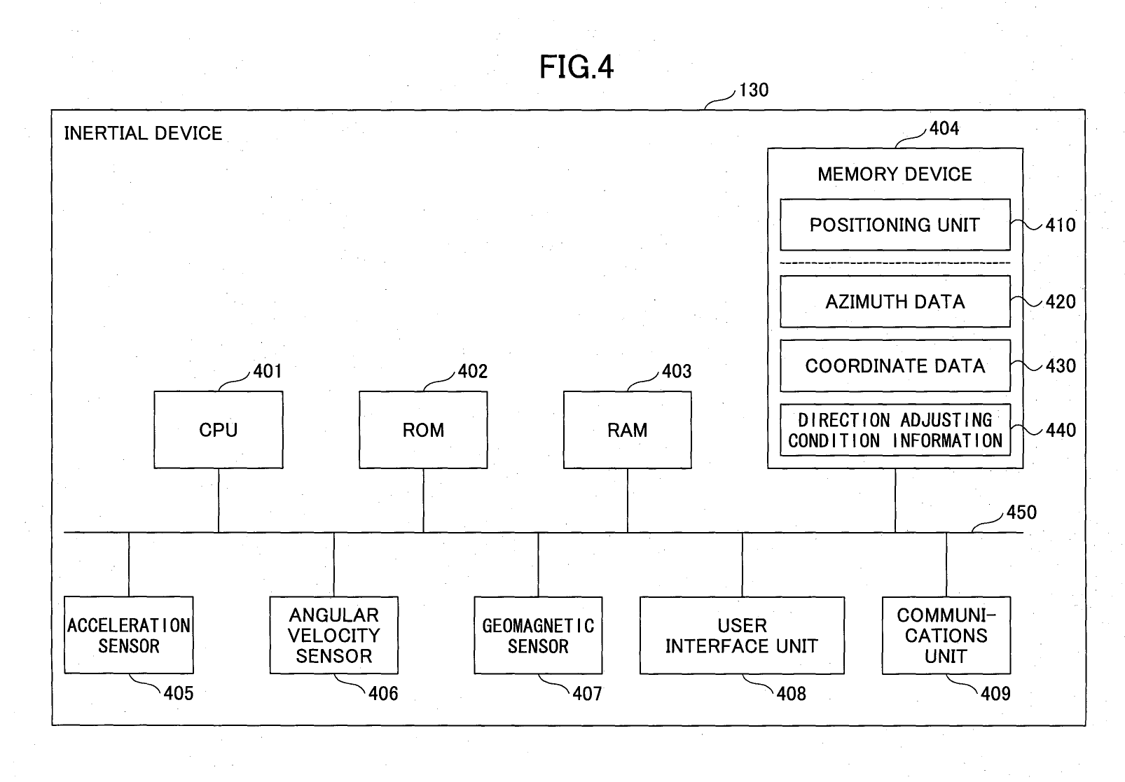

Next, a configuration of the inertial device 130 according to an embodiment of the present invention will be described. FIG. 4 is a drawing illustrating a hardware configuration of the inertial device 130 according to an embodiment of the present invention.

As shown in FIG. 4, the inertial device 130 includes a CPU (Central Processing Unit) 401, a ROM (Read Only Memory) 402, a RAM (Random Access Memory) 403 and a memory device 404. Furthermore, the inertial device 130 includes an acceleration sensor 405, an angular velocity sensor 406, a geomagnetic sensor 407, a user interface unit 408 and a communications unit 409. It should be noted that units of the inertial device 130 are connected to each other via a bus 450.

The CPU 401 is a processor for executing a program which is stored in the memory device 404 and functions as a positioning unit 410.

By executing a program functioning as the positioning unit 410, the inertial device 130 calculates an acceleration in an absolute coordinate system based on detection results of the sensors and calculates azimuth data indicating a direction of travel of the user and coordinate data indicating a position of the user. Also, the inertial device 130 determines whether a calculated predetermined amount of coordinate data satisfies a direction adjusting condition (details will be described later) and, in the case where it is determined that the condition is satisfied, calculates a direction error estimate value which is an amount of misalignment of the azimuth data indicating the direction of travel of the user. Furthermore, the inertial device 130 adjusts the acceleration in the absolute coordinate system based on the calculated direction error estimate value.

The ROM 402 is a non-volatile memory. The ROM 402 stores various kinds of programs, data and the like which are needed for the CPU 401 to execute a program stored in the memory device 404. Specifically, the ROM 402 stores a BIOS (Basic Input/Output System), a boot program including an EFI (Extensible Firmware Interface), and the like.

The RAM 403 is a main memory device including a DRAM (Dynamic Random Access Memory), an SRAM (Static

Random Access Memory), or the like. The RAM 403 functions as a work area in which a program stored in the memory device 404 is read/written when the CPU 401 executes the program.

The memory device 404 stores a program which causes the CPU 401 to function as the positioning unit 410. Also, the memory device 404 stores azimuth data 420 and coordinate data 430 calculated by execution of the program. Furthermore, the memory device 404 stores direction adjusting condition information 440 which is used when calculating a direction error estimate value which is an amount of misalignment of the calculated azimuth data 420.

The acceleration sensor 405 detects an acceleration of a user wearing the inertial device 130, and outputs a signal indicating an acceleration vector as a detection result. The angular velocity sensor 406 detects an angular velocity of the user, and outputs a signal indicating an angular velocity vector as a detection result. The geomagnetic sensor 407 detects a magnetic direction of the user, and outputs a signal indicating a magnetic direction vector as a detection result.

The user interface unit 408 includes screens for inputting various kinds of instructions for the inertial device 130 and for displaying internal states of the inertial device 130. Furthermore, the user interface unit 408 includes various kinds of operation buttons or the like.

The communications unit 409 transmits positioning data 140 (coordinate data) to the positioning server apparatus 110 via the access point 120 at a predetermined cycle (e.g., one second cycle).

### 5. FUNCTIONAL CONFIGURATION OF POSITIONING UNIT

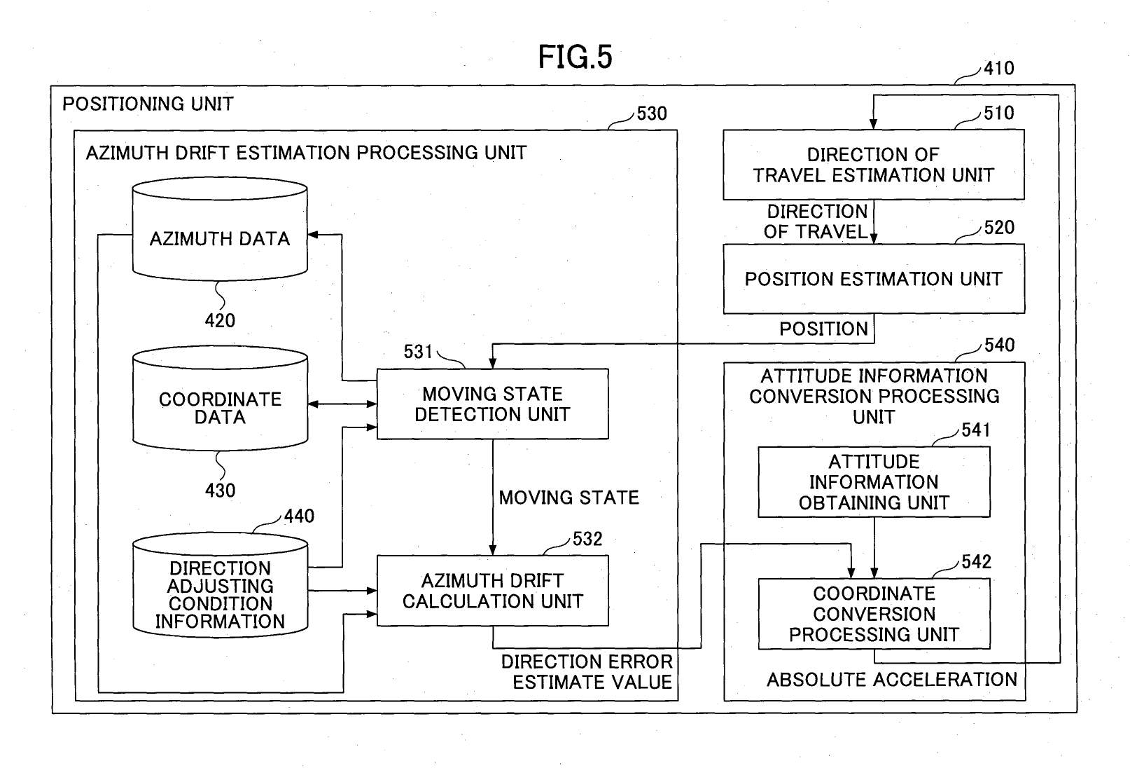

Next, a functional configuration of the positioning unit 410 will be described. FIG. 5 is a drawing illustrating a functional configuration of the positioning unit 410 of the inertial device 130.

As shown in FIG. 5, the positioning unit 410 includes a direction of travel estimation unit 510, a position estimation unit 520, an azimuth drift estimation processing unit 530 and an attitude information conversion processing unit 540.

The direction of travel estimation unit 510 performs a direction of travel estimation function for estimating azimuth data indicating a direction of travel of a user. Specifically, the direction of travel estimation unit 510 calculates azimuth data indicating the direction of travel for each step of the user from triaxial acceleration (absolute acceleration) in the absolute coordinate system obtained by the attitude information conversion processing unit 540.

The position estimation unit 520 performs a position estimation function for estimating coordinate data indicating a position of a user. Specifically, using the azimuth data indicating the direction of travel: and various kinds of values (walking behavior parameters) calculated in the direction of travel estimation unit 510 when estimating azimuth data indicating the direction of travel, the position estimation unit 520 calculates coordinate data indicating a position for each step of the user.

The azimuth drift estimation processing unit 530 determines a moving state of the user based on the predetermined amount of coordinate data calculated by the position estimation unit 520, and, in the case where it is determined that the determined moving state satisfies a direction adjusting condition, calculates a direction error estimate value.

The attitude information conversion processing unit 540 calculates a triaxial acceleration (absolute acceleration) in the absolute coordinate system by using attitude information of the inertial device 130 (a rotation matrix obtained by calculating an attitude of the inertial device 130) calculated based on detection results of the sensors. Also, in the case where the direction error estimate value is reported by the azimuth drift estimation processing unit 530, the attitude information conversion processing unit 540 adjusts the calculated absolute acceleration by using the direction error estimate value. Furthermore, the attitude information conversion processing unit 540 reports the adjusted absolute acceleration to the direction of travel estimation unit 510.

In the following, each of the units (the direction of travel estimation unit 510, the position estimation unit 520, the azimuth drift estimation processing unit 530 and the attitude information conversion processing unit 540) included in the positioning unit 410 will be described in detail.

### 6. CONFIGURATION OF DIRECTION OF TRAVEL ESTIMATION UNIT AND POSITION ESTIMATION UNIT

### <6.1 Configuration of Direction of Travel Estimation Unit>

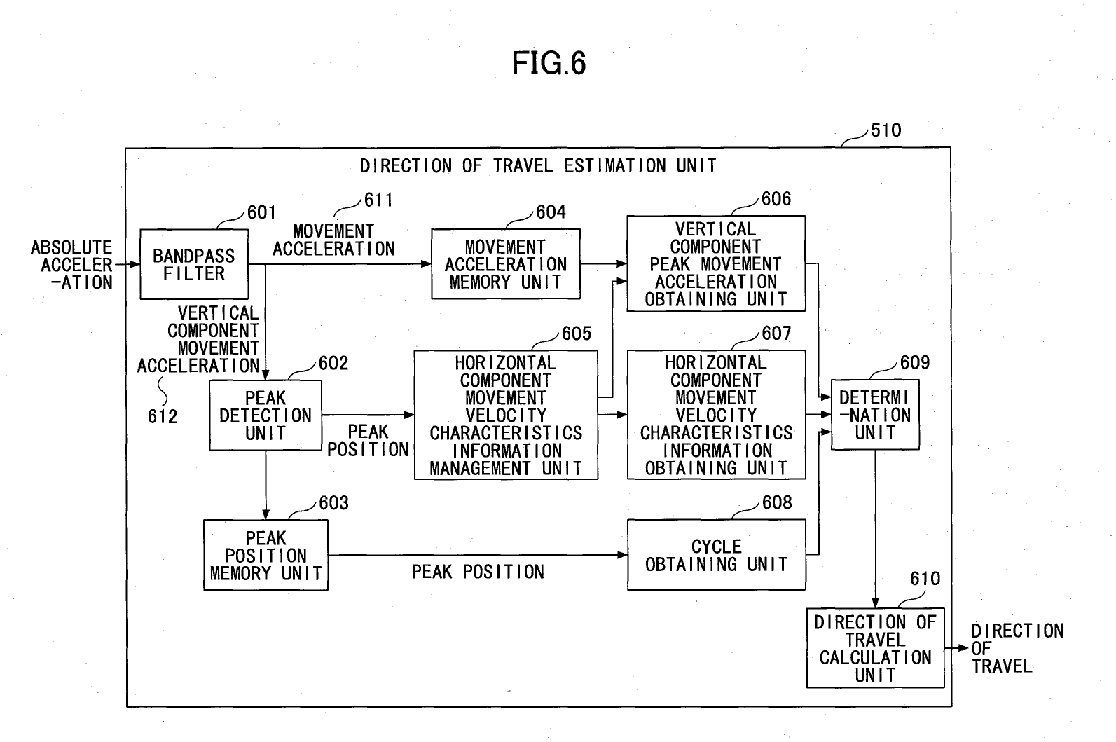

First, a configuration of the direction of travel estimation unit 510 will be described. As described above, the direction of travel estimation unit 510 calculates azimuth data indicating a direction of travel for each step of the user from the absolute acceleration reported by the attitude information conversion processing unit 540. FIG. 6 is a drawing illustrating a functional configuration of the direction of travel estimation unit 510.

As shown in FIG. 6, the direction of travel estimation unit 510 includes a bandpass filter 601, a peak detection unit 602, a peak position memory unit 603, a movement acceleration memory unit 604 and a horizontal component movement velocity characteristics information management unit 605. Furthermore, the direction of travel estimation unit 510 includes a vertical component peak movement acceleration obtaining unit 606, a horizontal component movement velocity characteristics information obtaining unit 607, a cycle obtaining unit 608, a determination unit 609 and a direction of travel calculation unit 610.

The bandpass filter 601 removes a gravity component from the absolute acceleration reported by the attitude information conversion processing unit 540. It is assumed that a passband of the bandpass filter 601 is, for example, typical walking frequencies on the order of 1 through 3 Hz. It should be noted that the passband may be changed accordingly depending on a frequency of steps or movement of the user wearing the inertial device 130. Here, an absolute acceleration during the movement, which is output by the bandpass filter 601 and from which the gravity component has been removed, is referred to as movement acceleration 611. The movement acceleration 611 is stored in the movement acceleration memory unit 604. Also, vertical component movement acceleration 612, which is a vertical component of the movement acceleration, is input to the peak detection unit 602.

The peak detection unit 602 monitors changes of the vertical component movement acceleration 612 (changes with respect to time) of the movement acceleration 611 output from the bandpass filter 601, and detects a position of a peak (bottom peak) of the wave form (a peak time or a peak position). The detected peak position is stored in the peak position memory, unit 603.

The peak position memory unit 603 stores the peak position detected by the peak detection unit 602. The peak position memory unit 603 stores, for example, by using a ring buffer, peak positions (times) from the latest to those corresponding to a predetermined past time area. The peak position memory unit 603 stores at least the latest peak position and one peak position in the past, which are updated by newly obtained peak positions at any time. It should be noted that the number of stored peak positions may be changed according to the memory capacity of the inertial device 130.

The movement acceleration memory unit 604, after adding observed time information to the movement accelerations 611 output from the bandpass filter 601, stores the movement accelerations 611 as time-series data.

The horizontal component movement velocity characteristics information management unit 605 calculates a horizontal velocity by a process integrating horizontal components of movement acceleration for each component (X, Y) in a predetermined cycle whose center is the peak position according to the detection of the peak position by the peak detection unit 602. This horizontal velocity is referred to as horizontal component movement velocity characteristics information. The horizontal component movement velocity characteristics information is a vector indicating relative values for a direction and a magnitude of the speed. The horizontal component movement velocity characteristics information management unit 605 stores the horizontal component movement velocity characteristics information along with the time information. In this way, the horizontal component movement velocity characteristics information management unit 605 has a function as a calculation unit for calculating the horizontal component movement velocity characteristics information and a function as a memory unit for storing the horizontal component movement velocity characteristics information.

The horizontal component movement velocity characteristics information is generated by the above peak detection process and the following series of processes, the moment when a pivot foot is overtaken by the other foot due to the forward movement of the other foot. The generated horizontal component movement velocity characteristics information represents a direction (direction of travel) and a strength of movement of a walking user the moment the pivot foot is overtaken by the other foot.

The vertical component peak movement acceleration obtaining unit 606 obtains a movement acceleration in the vertical component movement acceleration 612 corresponding to the peak position (time) (vertical component peak movement acceleration), and passes this acceleration to the determination unit 609.

The horizontal component movement velocity characteristics information obtaining unit 607 obtains the latest horizontal component movement velocity characteristics information and the horizontal component movement velocity characteristics information in the past and passes the obtained horizontal component movement velocity characteristics information to the determination unit 609.

The cycle obtaining unit 608 obtains a plurality of the peak positions from the peak position memory unit 603 and performs a conversion process for converting them into a walking cycle of the user. Also, the cycle obtaining unit 608 can obtain, by calculating in order differences between the peak positions, the latest walking cycle and the walking cycles in the past. The cycle obtaining unit 608 passes the obtained walking cycles to the determination unit 609.

The determination unit 609 determines whether the various types of information obtained so far are derived from a walking behavior or not. The walking behavior is a movement of a user including a walking movement and a running movement. On the other hand, a non-walking behavior is a behavior of moving the inertial device 130 arbitrarily or intentionally, or a behavior not caused by a movement of the user alone as in a case where the inertial device 130 receives an acceleration from an external environment (for example, in a case where the inertial device 130 is caused to move by an external moving object).

Then, the determination unit 609 determines whether the various types of information obtained so far are derived from the walking behavior or not based on the determination whether each of

a vertical component peak movement acceleration obtained by the vertical component peak movement acceleration obtaining unit 606,

horizontal component movement velocity characteristics information (vector) calculated by the horizontal component movement velocity characteristics information management unit 605,

a walking cycle obtained by the cycle obtaining unit 608, and

a variance width of movement velocities for the left and right, calculated based on the horizontal component movement velocity characteristics information (vector) and managed by the horizontal component movement velocity characteristics information management unit 605, is within a corresponding predetermined range or not. In the case where all of the above data are within the predetermined ranges, it is determined that the above data are obtained due to a walking behavior. On the other hand, in the case where any one of the above data is out of the predetermined range, it is determined that the above data are obtained due to a non-walking behavior.

In the direction of travel calculation unit 610, in the case where it is determined by the determination unit 609 that the above data are obtained due to a walking behavior, in order to obtain the azimuth data indicating a direction of travel for each step, the following process will be performed.

That is, when a user moves from a zero step to a first step, a horizontal component movement velocity characteristics vector V0 is obtained from the horizontal component movement velocity characteristics information obtaining unit 607. Also, when a user moves from the first step to a second step, a horizontal component movement velocity characteristics vector V1 is obtained from the horizontal component movement velocity characteristics information obtaining unit 607. Then, a combined vector (V0+V1) is calculated, and it is assumed that the direction of the combined vector is azimuth data indicating direction of travel of the user for each step. The above process is performed every time the user takes a new step forward.

### <6.2 Configuration of Position Estimation Unit>

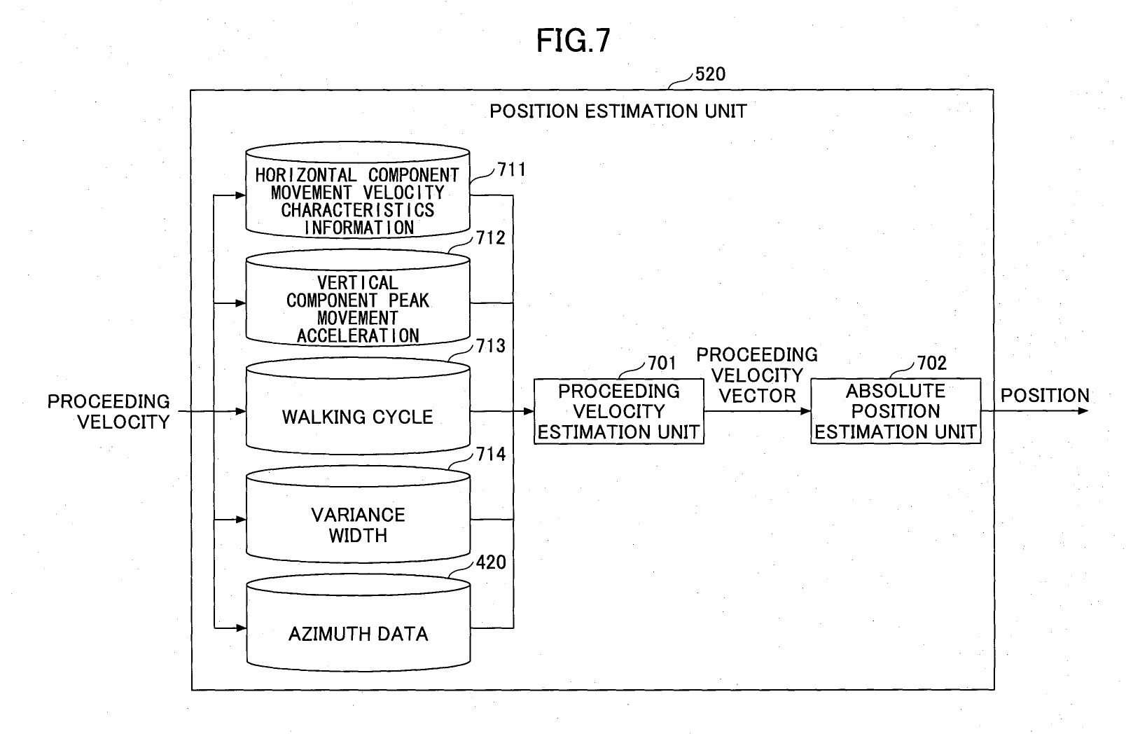

Next, a configuration of the position estimation unit 520 will be described. FIG. 7 is a drawing illustrating a functional configuration of the position estimation unit 520.

As shown in FIG. 7, the position estimation unit 520 includes a proceeding velocity estimation unit 701 and an absolute position estimation unit 702.

The proceeding velocity estimation unit 701, by using azimuth data 420 indicating a direction of travel estimated by the direction of travel estimation unit 510 and various types of values calculated when the azimuth data 420 are estimated (referred to as walking behavior parameters), a proceeding velocity estimate vector indicating a proceeding velocity of the user is calculated. It should be noted that the various types of values calculated when the azimuth data indicating the direction of travel are estimated include horizontal component movement velocity characteristics information 711, a vertical component peak movement acceleration 712, a walking cycle 713, and a variance width 714.

The absolute position estimation unit 702 estimates coordinate data indicating the user's position from the proceeding velocity estimate vector calculated by the proceeding velocity estimation unit 701 by utilizing addition with a Kalman Filter. Also, the estimated coordinate data is reported to the azimuth drift estimation processing unit 530.

### <6.3 Flow of Direction of Travel and Position Estimation Process>

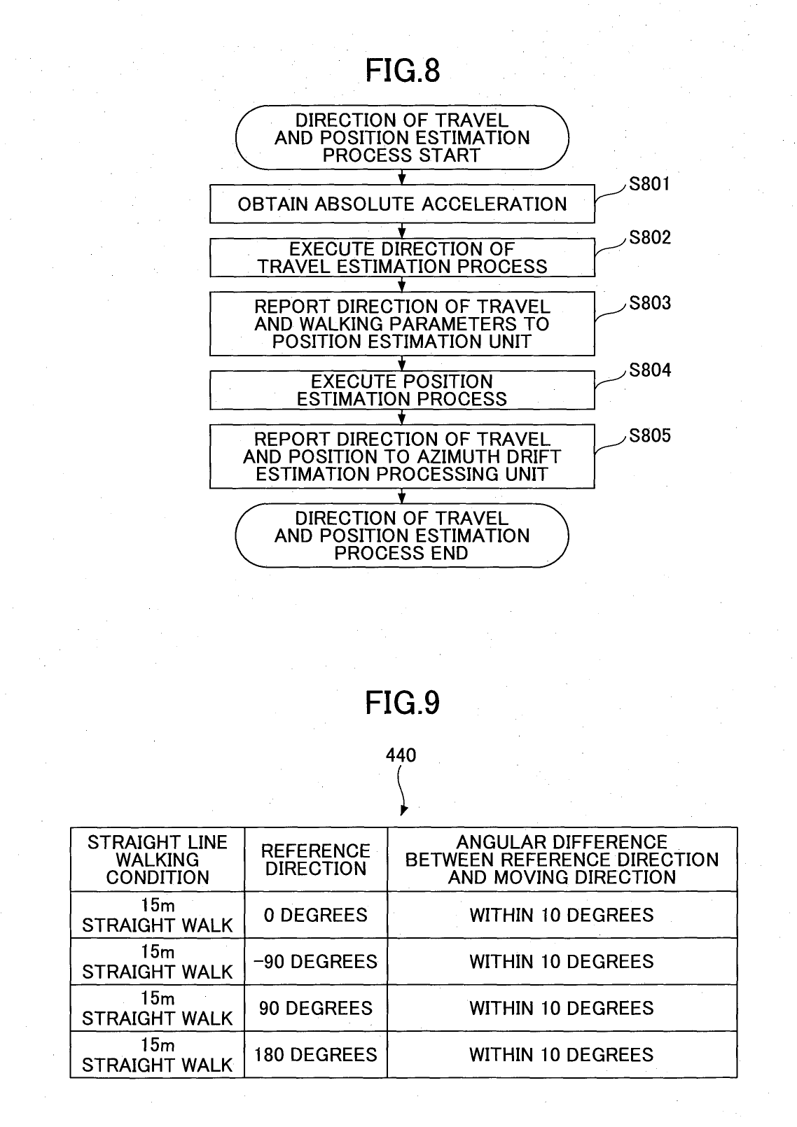

Next, a flow of direction of travel and position estimation process by the direction of travel estimation unit 510 and the position estimation unit 520 will be described. FIG. 8 is a flowchart illustrating a direction of travel and position estimation process by the direction of travel estimation unit 510 and the position estimation unit 520.

In step S801, the direction of travel estimation unit 510 obtains the absolute acceleration reported by the attitude information conversion processing unit 540. In step S802, the direction of travel estimation unit 510 estimates azimuth data indicating the direction of travel of the user based on the obtained absolute acceleration.

In step S803, the direction of travel estimation unit 510 reports to the position estimation unit 520 the azimuth data indicating the direction of travel estimated in step S802 and the various types of values (walking behavior parameters) calculated when the azimuth data indicating the direction of travel are estimated.

In step S804, based on the azimuth data and the walking behavior parameters reported by the direction of travel estimation unit 510, the position estimation unit 520 estimates coordinate data indicating a position of the user.

In step S805, the position estimation unit 520 reports to the azimuth drift estimation processing unit 530 the azimuth data indicating the direction of travel and the coordinate data indicating the position.

### 7. CONFIGURATION OF AZIMUTH DRIFT ESTIMATION PROCESSING UNIT>

Next, referring to FIG. 5, the azimuth drift estimation processing unit 530 included in the positioning unit 410 will be described. As shown in FIG. 5, the azimuth drift estimation processing unit 530 includes a moving state detection unit 531 and an azimuth drift calculation unit 532.

The moving state detection unit 531 obtains at a predetermined cycle the azimuth data 420 indicating the direction of travel estimated by the direction of travel estimation unit 510 and the coordinate data 430 indicating the position estimated by the position estimation unit 520, and stores them in the memory device 404.

Also, by using the past coordinate data 430 stored in the memory device 404, the moving state detection unit 531 determines a moving state of the user. Furthermore, the moving state detection unit 531 reports the determined moving state to the azimuth drift calculation unit 532.

It should be noted that the moving state mentioned here refers to a characteristic walking state of the user such as “the user has walked in which direction for how many meters in a straight line” based on the predetermined amount of coordinate data.

The azimuth drift calculation unit 532 compares the information indicating the moving state reported by the moving state detection unit 531 with the direction adjusting condition information 440, and determines whether the reported information indicating the moving state satisfies a direction adjusting condition defined by the direction adjusting condition information 440 or not. Also, in the case where the reported information indicating the moving state satisfies the direction adjusting condition, a direction error estimate value is calculated. Furthermore, the calculated direction error estimate value is reported to the attitude information conversion processing unit 540. In the following, the details of the moving state detection unit 531 and the azimuth drift calculation unit 532 included in the azimuth drift estimation processing unit 530, and the details of the direction adjusting condition information 440 will be described.

### <7.1 Description of Direction Adjusting Condition Information>

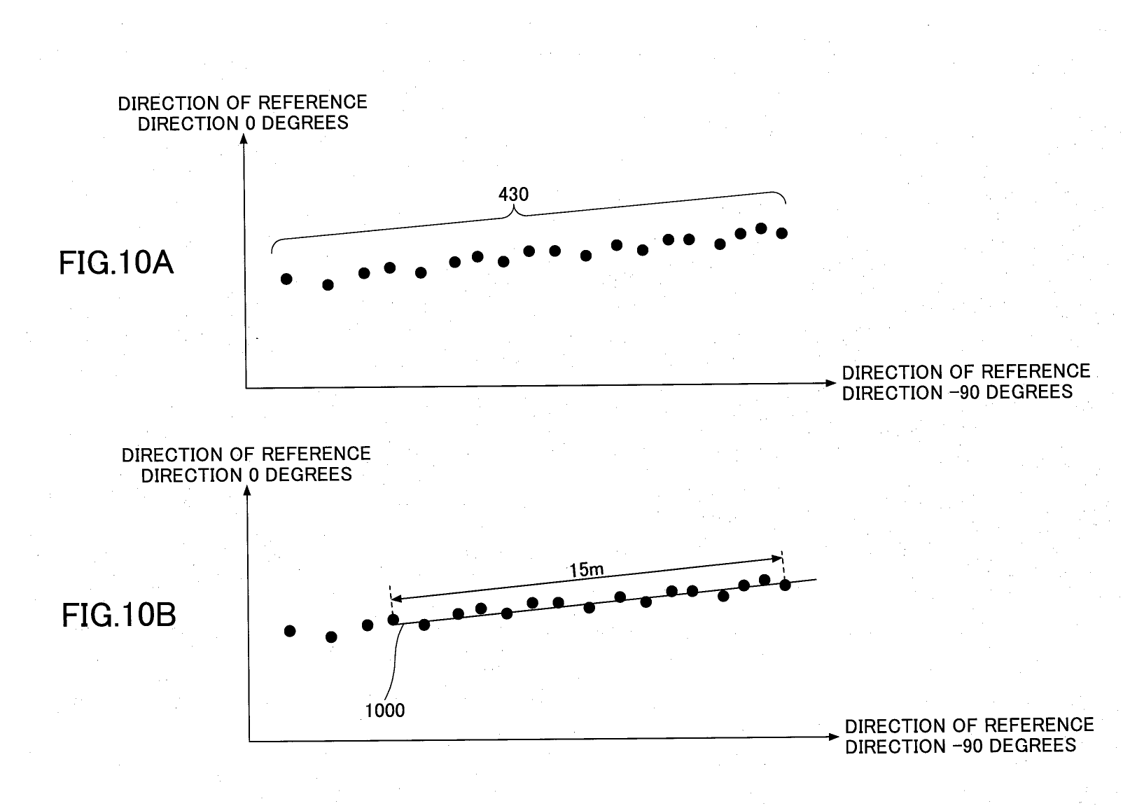

First, the direction adjusting condition information 440 is described. FIG. 9 is a drawing illustrating an example of the direction adjusting condition information 440. The direction adjusting condition information 440 is information which defines the direction adjusting condition which is used when the direction error estimate value is calculated.

In general, in a building including an office, it is often the case that corridors are linear and orthogonal to each other and dominant areas are used for walking a long distance in a straight line. Therefore, if a direction of a specific corridor is defined as 0 degrees or 180 degrees, then the direction of a corridor orthogonal to the specific corridor may be defined as 90 degrees or −90 degrees.

In other words, in a building including an office, in the case where it is detected that a user walks long distance in a straight line, there is a high likelihood that a moving direction of the user (a direction in which the user has walked for a predetermined section) is 0 degrees, 180 degrees, 90 degrees, or −90 degrees. Therefore, in order to utilize the positioning system 100 in a building including an office, first, directions of corridors are defined as reference directions of 0 degrees, 180 degrees, 90 degrees and −90 degrees. Then, in the case where it is detected that a user walks a long distance in a straight line, a direction error estimate value is calculated based on any one of the reference directions, and an absolute acceleration is adjusted based on the calculated direction error estimate value. By this adjustment, azimuth data indicating the direction of travel, which is calculated based on the adjusted absolute acceleration, are also adjusted. In other words, azimuth data indicating the direction of travel are adjusted every time a user is detected walking a long distance in a straight line, thereby adjustment frequency is increased. As a result, it becomes possible to avoid such a situation where calculation accuracy of azimuth data decreases as time passes; thereby the calculation accuracy of the azimuth data can be increased.

In an example of FIG. 9, in a inertial device 130, it is determined that a direction adjusting condition is satisfied in the case where a user is detected walking 15 meters in a straight line and an angle difference between the moving direction of the detected straight line walk and one of the reference directions of 0 degrees, −90 degrees, 90 degrees and 180 degrees is equal to or less than 10 degrees.

It should be noted that the direction adjusting condition information 440 is set based on the map information 220 of the building by which the positioning system 100 is utilized. Specifically, first, linear corridors included in the map information 220 stored in the positioning server apparatus 110 are extracted, and the extracted corridors are grouped based on the directions they extend. Then, by defining a direction of one specific group of corridors as 0 degrees, directions of other groups of corridors are defined. Furthermore, by analyzing the lengths of corridors of each group, a straight line walking condition is defined.

In an example of FIG. 9, it is shown that all of the corridors extracted from the map information 220 have a length greater than or equal to 15 meters and belong to one of the groups of directions 0 degrees, −90 degrees, 90 degrees and 180 degrees. Therefore, in the direction adjusting condition information 440, “walking 15 meters in a straight line” is defined as a straight line walking condition and “0 degrees, −90 degrees, 90 degrees and 180 degrees” are defined as reference directions.

### <7.2 Description of Moving State Detection Unit>

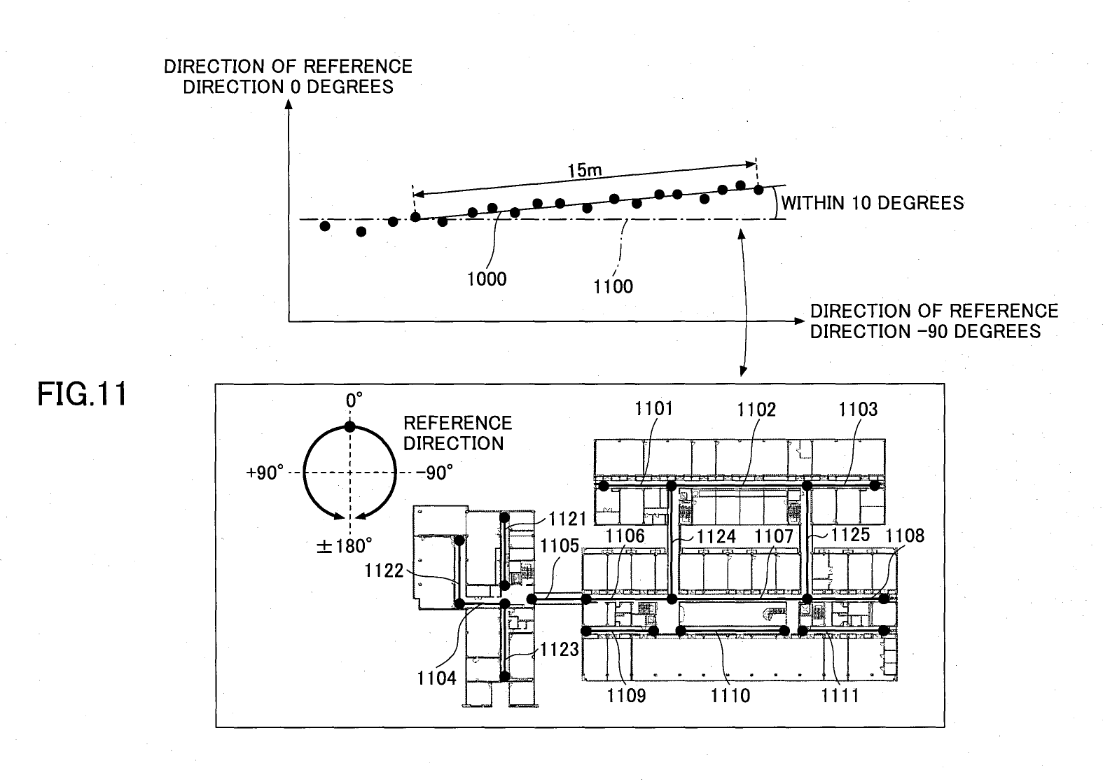

Next, a process in the moving state detection unit 531 is described. FIGS. 10A and 10B are drawings describing a process in the moving state detection unit 531.

FIG. 10A shows an example of coordinate data 430 stored in the memory device 404 at a predetermined cycle. In FIG. 10A, the horizontal axis indicates a direction of the reference direction −90 degrees and the vertical axis indicates a direction of the reference direction 0 degrees. Also, a dot plotted in FIG. 10A indicates the coordinate data 430 at each cycle, a dot plotted at the left end indicates the coordinate data 430 calculated at the beginning and a dot plotted at the right end indicates the coordinate data calculated at the present time, respectively.

FIG. 10B shows an aspect in which the moving state detection unit 531 calculates an approximate straight line 1000 by using these coordinate data 430. The approximate straight line 1000 can be calculated, for example, by the method of least squares using the coordinate data 430, and can indicate the moving direction of the user. It should be noted that FIG. 10B indicates that the length of the approximate straight line 1000, which is calculated by using as many as 15 coordinate data sets going backwards starting from the coordinate data calculated at the present time, is 15 m.

In this way, in the moving state detection unit 531, approximate straight lines are continually calculated by extracting the coordinate data 430 going backwards starting from the coordinate data 430 calculated at the present time from the coordinate data 430 which are continually stored in the memory device at a predetermined cycle. Furthermore, the lengths of the calculated approximate straight lines (the length from one end point to the other end point of the extracted coordinate data) are continually calculated. And, in the case where the length of calculated approximate straight line 1000 becomes equal to or greater than 15 m (which is defined in the straight line walking condition), it is determined that the straight line walk equal to or longer than 15 m is performed by the user, and the calculated approximate straight line 1000 is reported as information indicating the moving state to the azimuth drift calculation unit 532.

### <7.3 Description of Azimuth Drift Calculation Unit>

Next, a process in the azimuth drift calculation unit 532 is described. First, as a process in the azimuth drift calculation unit 532, a process for determining whether the information indicating the moving state reported by the moving state detection unit 531 satisfies the direction adjusting condition information 440 is described.

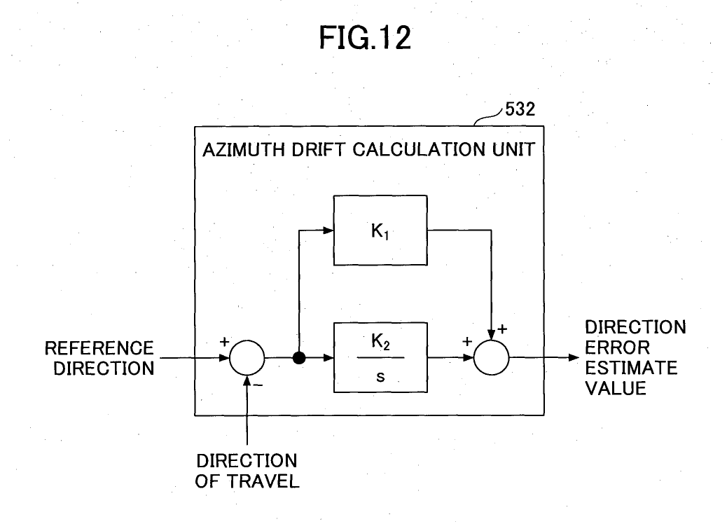

FIG. 11 is a drawing illustrating an aspect of comparing the information indicating the moving state reported by the moving state detection unit 531 with the direction adjusting condition information 440. In FIG. 11, a straight line 1100 is a straight line indicating the reference direction −90 degrees.

As shown in the lower side of FIG. 11, the map information 220 includes corridors 1121 through 1125 which are corridors of the reference direction 0 degrees or 180 degrees and are equal to or longer than 15 m. Also, the map information 220 includes corridors 1101 through 1111 which are corridors of the reference direction 90 degrees or −90 degrees and are equal to or longer than 15 m.

Here, an example of FIG. 11 illustrates a case in which an angle difference between the approximate straight line 1000 calculated by the moving state detection unit 531 and the line 1100 indicating the reference direction −90 degrees is equal to or less than 10 degrees (equal to or less than a predetermined angle difference). Therefore, in the azimuth drift calculation unit 532, it is determined that the user is walking in one of the corridors 1101 through 1111 of the reference direction −90 degrees. In other words, it is determined that the information indicating the moving state reported by the moving state detection unit 531 satisfies the direction adjusting condition.

Next, as a process in the azimuth drift calculation unit 532, a process is described for calculating a direction error estimate value which is performed in a case where it is determined that the information indicating the moving state reported by the moving state detection unit 531 satisfies the direction adjusting condition information.

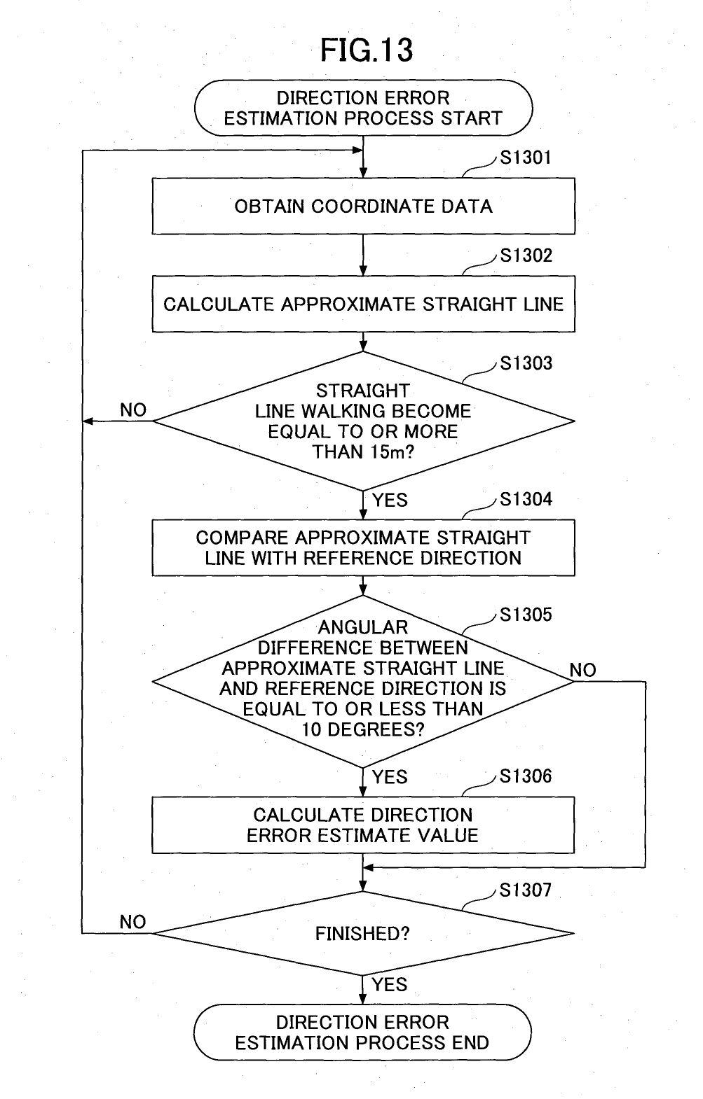

FIG. 12 is a drawing for describing a process for calculating the direction error estimate value in the azimuth drift calculation unit 532. As shown in FIG. 12, the azimuth drift calculation unit 532 calculates the direction error estimate value by using a framework of PI control.

In FIGS. 12, K1 and K2 represent a proportional gain and an integral gain, respectively. As shown in FIG. 12, in the azimuth drift calculation unit 532, first, a deviation (angular difference) between the reference direction (here, −90 degrees) and a direction of travel indicated by the azimuth data 420 calculated at the present time is multiplied by the proportional gain K1. Subsequently, the integral gain K2 is multiplied by a value which is obtained by integrating for a predetermined integral time the deviation (angular difference) between the reference direction (here, −90 degrees) and the direction of travel indicated by the azimuth data 420. Then, by adding both results, the direction error estimate value is obtained. Specifically, the direction error estimate value is calculated according to the following equation.

$$ψ ( t ) = {K}_{1} ( Δ ψ ( t ) + \frac{1}{{T}_{I}} {\int }_{t - ti}^{t} Δ ψ ( τ ) d τ )$$

In the above equation,
φ(t): direction error estimate value
Δ φ (t): angular difference between the reference direction and the direction of travel at the present time t
TI: integral gain (K1/TI=K2)
ti: integral time
Δφ (τ): angular difference between the reference direction and the direction of travel at any given time τ within the integral time

In this way, in the present embodiment, the angular difference Δψ(t) is not directly used as a direction error estimate value and the direction error estimate value is calculated by using a framework of PI control. The above configuration is used in order to avoid a situation in which the stability of the direction error estimate value is decreased and the value gets diverged under a unique situation.

In other words, by calculating the direction error estimate value using a framework of PI control, it becomes possible to perform estimation with high robustness.

### <7.4 Flow of a Process of Direction Error Estimation>

Next, a flow of a direction error estimation process in an azimuth drift estimation processing unit 530 is described.

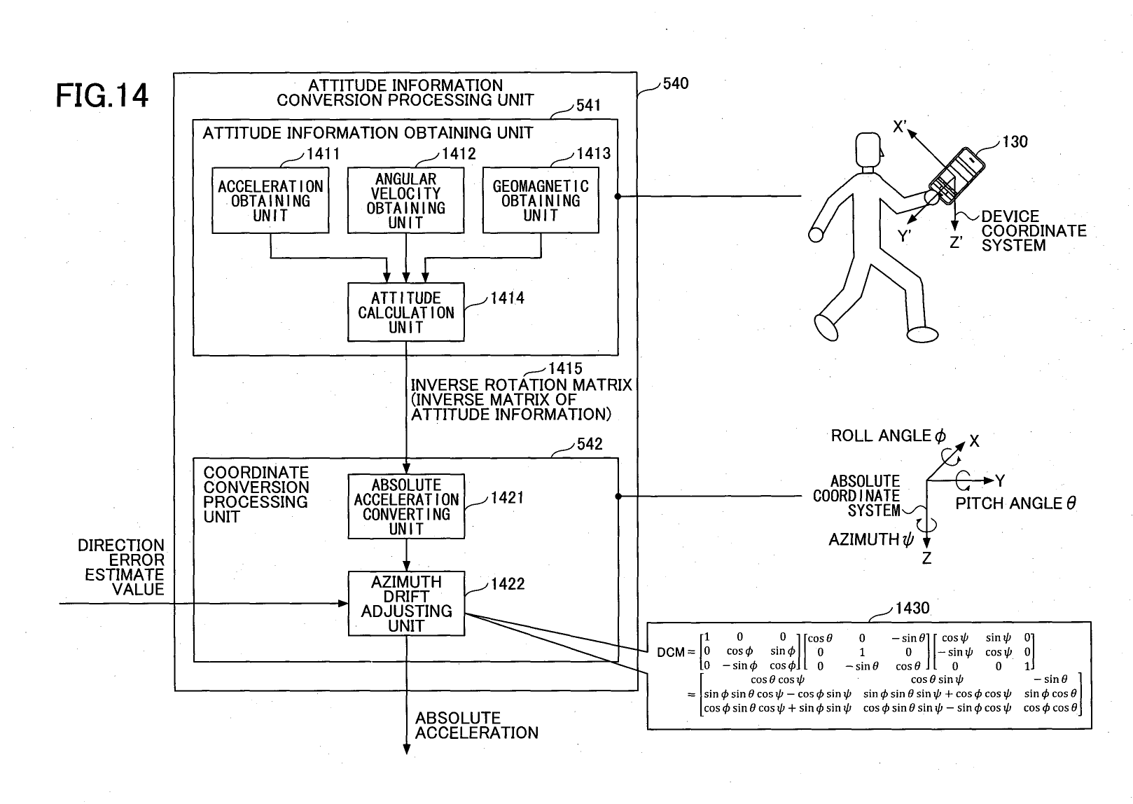

FIG. 13 is a flowchart illustrating the direction error estimation process in the azimuth drift estimation processing unit 530. As shown in FIG. 13, in step S1301, the moving state detection unit 531 obtains coordinate data 430 calculated by the position estimation unit 520.

In step S1302, based on the obtained coordinate data 430, the moving state detection unit 531 calculates the approximate straight line 1000.

In step S1303, based on the approximate straight line 1000 calculated in step S1302, the moving state detection unit 531 determines whether the length of straight line walk of the user becomes equal to or greater than 15 m. In the case where it is determined that the length has not become equal to or greater than 15 m instep S1303, the flow returns to step S1301, the next coordinate data are obtained, and the approximate straight line 1000 is calculated again.

On the other hand, in the case where it is determined that the length has become equal to or greater than 15 m in step S1303, the flow moves to step S1304 and the azimuth drift calculation unit 532 compares the calculated approximate straight line 1000 and the reference directions.

In the case where it is determined that, as a result of comparison in step S1304, the angular difference between the approximate straight line 1000 and one of the reference directions is equal to or less than 10 degrees, it is determined that the direction adjusting condition is satisfied and the flow moves from step 1305 to step S1306.

In step S1306, the azimuth drift calculation unit 532 calculates, based on the deviation (angular difference) between the reference direction and the direction of travel at the present time, a direction error estimate value at the present time.

On the other hand, in the case where it is determined that, as a result of comparison in step S1305, the angular difference between the approximate straight line 1000 and any one of the reference directions is not equal to or less than 10 degrees, it is determined that the direction adjusting condition is not satisfied and the flow moves from step 1305 to step S1307.

In step S1307, it is determined whether the direction error estimation process should be finished, and in the case where it is determined that the process should not be finished, the flow returns to step S1301. On the other hand, in the case where it is determined that the process should be finished, the whole process of direction error estimation is ended.

### 8. DESCRIPTION OF ATTITUDE INFORMATION CONVERSION PROCESSING UNIT

Next, an attitude information conversion processing unit 540 included in the positioning unit 410 is described. As shown in FIG. 5, the attitude information conversion processing unit 540 includes an attitude information obtaining unit 541 and a coordinate conversion processing unit 542. In the attitude information conversion processing unit 540, by applying coordinate conversion, a triaxial acceleration in a device coordinate system obtained by the attitude information obtaining unit 541 is converted to a triaxial acceleration in an absolute coordinate system by the coordinate conversion processing unit 542, and thereby an absolute acceleration is calculated. Furthermore, based on the direction error estimate value, the calculated absolute acceleration is adjusted.

It should be noted that the device coordinate system is a coordinate system in which a point on the inertial device 130 is defined as an origin, and three axises orthogonal to each other at the origin are defined.

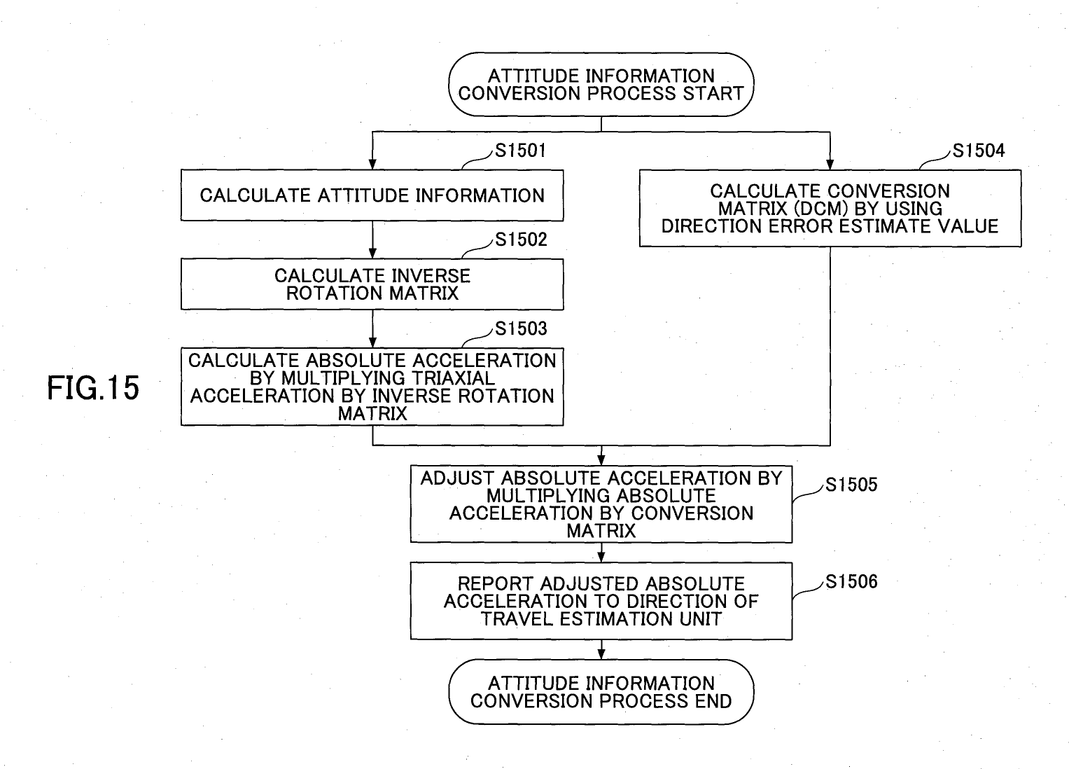

In the following, referring to FIG. 14, a functional configuration of the attitude information conversion processing unit 540 is described in detail.

### <8.1 Configuration of Attitude Information Obtaining Unit>

Of all units included in the attitude information conversion processing unit 540, first, a functional configuration of the attitude information obtaining unit 541 is described.

FIG. 14 is a drawing illustrating a functional configuration of the attitude information conversion processing unit 540. As shown in FIG. 14, the attitude information obtaining unit 541 included in the attitude information conversion processing unit 540 includes an acceleration obtaining unit 1411, an angular velocity obtaining unit 1412, a geomagnetic obtaining unit 1413, and an attitude calculation unit 1414.

The acceleration obtaining unit 1411 obtains a change of a triaxial acceleration detected by the acceleration sensor 405. The acceleration obtained here is fixed to a device coordinate system (X′, Y′, Z′). The angular velocity obtaining unit 1412 obtains a change of a triaxial angular velocity detected by the angular velocity sensor 406. The angular velocity obtained here is, the same as the acceleration, fixed to the device coordinate system (X′, Y′, Z′). The geomagnetic obtaining unit 1413 obtains a triaxial magnetic direction detected by the geomagnetic sensor 407. The direction obtained here is, the same as the acceleration, fixed to the device coordinate system (X′, Y′, Z′).

The attitude calculation unit 1414 calculates the current attitude of the inertial device 130 by using the detected results of the sensors obtained by the acceleration obtaining unit 1411, the angular velocity obtaining unit 1412, and the geomagnetic obtaining unit 1413. And, from the attitude information (rotation matrix) obtained by calculation, an inverse rotation matrix 1415 is obtained by applying inverse matrix calculation.

### 8. DESCRIPTION OF ATTITUDE INFORMATION CONVERSION PROCESSING UNIT

Next, of all units included in the attitude information conversion processing unit 540, a functional configuration of the coordinate conversion processing unit 542 is described referring to FIG. 14.

As shown in FIG. 14, the coordinate conversion processing unit 542 includes an absolute acceleration converting unit 1421 and an azimuth drift adjusting unit 1422.

The absolute acceleration converting unit 1421 converts a triaxial acceleration in a device coordinate system (coordinate system consisting of X′ axis, Y′ axis, and Z′ axis as shown in the upper right of FIG. 14) obtained by the attitude information obtaining unit 541 to a triaxial acceleration in an absolute coordinate system (coordinate system consisting of X axis, Y axis, and Z axis as shown in the middle right of FIG. 14). Specifically, a triaxial acceleration in the absolute coordinate system (absolute acceleration) is calculated by multiplying the acceleration obtained by the acceleration obtaining unit 1411 with the inverse rotation matrix 1415 calculated by the attitude calculation unit 1414.

The azimuth drift adjusting unit 1422 calculates a conversion matrix (DCM: Direction Cosine Matrix) for applying coordinate system conversion to an absolute acceleration based on the direction error estimate value reported by the azimuth drift calculation unit 532. Specifically, in a conversion matrix 1430 shown in FIG. 14, zero is assigned to a roll angle φ and a pitch angle θ, and the direction error estimate value ψ(t) reported by the azimuth drift calculation unit 532 is assigned to the azimuth ψ.

Furthermore, the azimuth drift adjusting unit 1422, by multiplying the absolute acceleration calculated by the absolute acceleration converting unit 1421 by the conversion matrix (DCM) 1430, adjusts the absolute acceleration and reports the adjusted absolute acceleration to the direction of travel estimation unit 510.

### <8.3 Flow of Attitude Information Conversion Process>

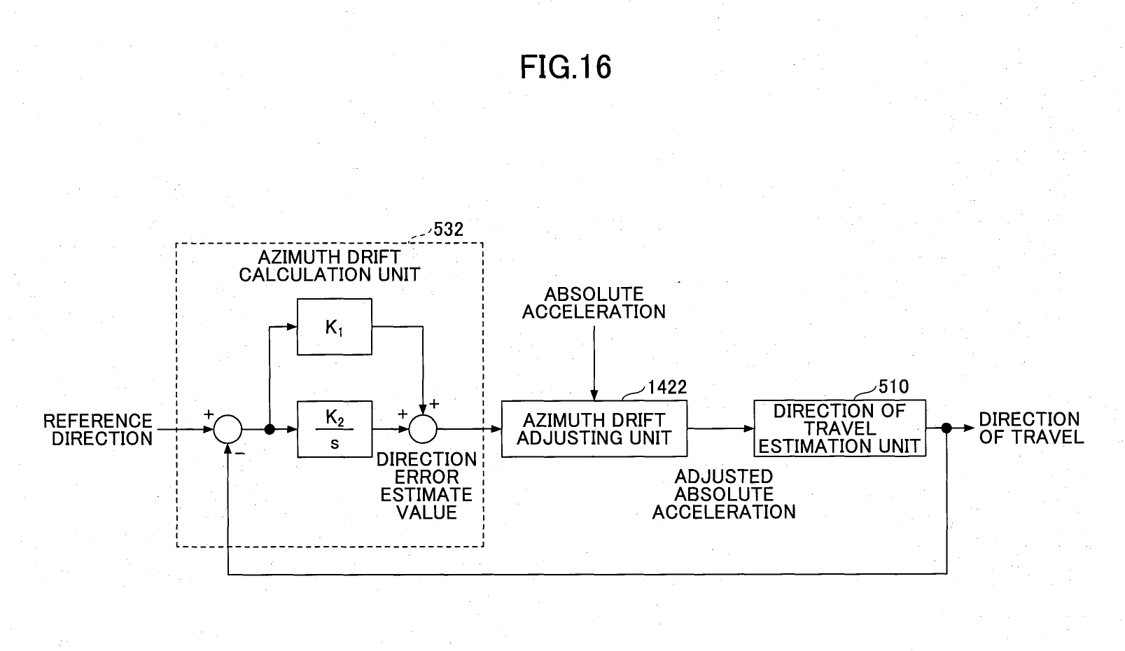

Next, a flow of an attitude information conversion process in the attitude information conversion processing unit 540 is described. FIG. 15 is a flowchart illustrating an attitude information conversion process by the attitude information conversion processing unit 540.

In step S1501, the attitude information obtaining unit 541 obtains a triaxial acceleration detected by the acceleration sensor 405, a triaxial angular velocity detected by the angular velocity sensor 406, and a triaxial magnetic direction detected by the geomagnetic sensor 407. Then, based on the obtained triaxial acceleration, the triaxial angular velocity, and the triaxial magnetic direction, attitude information (rotation matrix) of the inertial device 130 is calculated.

In step S1502, the attitude information obtaining unit 541 calculates the inverse rotation matrix 1415 from the attitude information (rotation matrix) calculated in step S1501.

In step S1503, the coordinate conversion processing unit 542 calculates, by multiplying the triaxial acceleration obtained in step S1501 by the inverse rotation matrix 1415 calculated in step S1502, a triaxial acceleration in the absolute coordinate system (absolute acceleration).

In step S1504, the azimuth drift adjusting unit 1422 calculates a conversion matrix (DCM) 1430 for applying coordinate system conversion to an absolute acceleration based on the direction error estimate value reported by the azimuth drift calculation unit 532.

In step S1505, the absolute acceleration is adjusted by multiplying the triaxial acceleration in the absolute coordinate system (absolute acceleration) calculated in step S1503 by the conversion matrix (DCM) 1430 based on the direction error estimate value calculated in step S1504. /

In step S1506, the absolute acceleration adjusted in step S1505 is reported to the direction of travel estimation unit 510.

### 9. AZIMUTH DATA ADJUSTING FUNCTION IN THE POSITIONING UNIT

An azimuth data adjusting function in which a misalignment of azimuth data is corrected by causing the units of the positioning unit 410 (the direction of travel estimation unit 510, the position estimation unit 520, the azimuth drift estimation processing unit 530, and the attitude information conversion processing unit 540) to be linked together will be described. FIG. 16 is a control block diagram of the azimuth data adjusting function implemented by the positioning unit 410. The control blocks shown in FIG. 16 are executed while the direction adjusting condition is satisfied.

Specifically, when the direction adjusting condition is satisfied, a direction error estimate value is calculated by the azimuth drift calculation unit 532 by using an angular difference between the direction of travel indicated by the azimuth data calculated this time and a reference direction.

The calculated direction error estimate value is input to the azimuth drift adjusting unit 1422 and is used for adjusting an absolute acceleration calculated based on an acceleration obtained in the next time. The absolute acceleration adjusted by the azimuth drift adjusting unit 1422 is input to the direction of travel estimation unit 510, and azimuth data indicating the direction of travel are calculated by the direction of travel estimation unit 510.

That is, the angular difference between the direction of travel indicated by the azimuth data which have already been calculated and the reference direction is reflected in the azimuth data which are newly calculated.

The azimuth data indicating the direction of travel calculated in the direction of travel estimation unit 510 are fed back to the azimuth drift calculation unit 532, and an angular difference between the direction of travel and the reference direction is calculated again by the azimuth drift calculation unit 532. In the azimuth drift calculation unit 532, a direction error estimate value according to the angular difference is further calculated, and the calculated direction error estimate value is input to the azimuth drift adjusting unit 1422.

The direction error estimate value input to the azimuth drift adjusting unit 1422 is used for adjusting the absolute acceleration calculated based on an acceleration to be obtained in the time after next. The absolute acceleration adjusted by the azimuth drift adjusting unit 1422 is input to the direction of travel estimation unit 510, and azimuth data indicating the direction of travel is calculated by the direction of travel estimation unit 510.

That is, the angular difference between the direction of travel indicated by the azimuth data which have already been calculated and the reference direction is reflected in the azimuth data which are newly calculated.

The azimuth data indicating the direction of travel calculated in the direction of travel estimation unit 510 are fed back to the azimuth drift calculation unit 532 again, and an angular difference between the direction of travel and the reference direction is calculated again by the azimuth drift calculation unit 532.

These processes are continued to be executed until when it is indicated by the moving state calculated based on coordinate data that the direction adjusting condition is not satisfied any more. In this way, in the inertial device 130, while the direction adjusting condition is satisfied, the absolute acceleration is continually adjusted by using a direction error estimate value calculated according to the deviation (angular difference) between the direction of travel and the reference direction so that the deviation (angular difference) between the direction of travel and the reference direction will disappear.

As a result, the misalignment of the azimuth data is corrected and it becomes possible to reduce the error of the coordinate data calculated based on the azimuth data.

### 10. EXAMPLES

Next, a movement trajectory calculated by the positioning server apparatus 110 by using the positioning data transmitted by the inertial device 130 will be described according to the present embodiments (inertial device in the case where a process for correcting the misalignment of the azimuth data is executed).

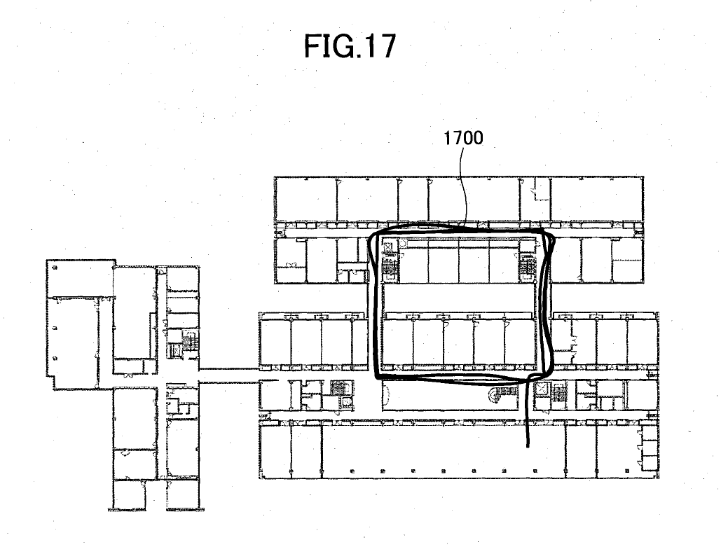

FIG. 17 is a drawing illustrating the movement trajectory 1700 calculated by the positioning server apparatus 110 by using the positioning data transmitted by the inertial device 130 according to the present embodiments (inertial device in the case where a process for correcting the misalignment of the azimuth data is executed).

It is clearly shown from the comparison with the movement trajectory 300 in FIG. 3B that the decreased calculation accuracy of the azimuth data can be avoided by adjusting the absolute acceleration by using the direction error estimate value, thereby the error of the coordinate data can be reduced even in the case where time has passed.

### 11. CONCLUSION

As is clearly shown in the above description, in the inertial device 130 according to the present embodiment, the followings are obtained.

A configuration is adopted in which it is determined that the direction adjusting condition is satisfied in the case where it is determined that the user has made a straight line walk equal to or greater than a predetermined length, the angular difference between the direction of travel of the user at the moment and the reference direction is within a predetermined angular difference, and a direction error estimate value is calculated.

A configuration is adopted in which directions of corridors in a building including an office where the user exists are used as reference directions.

A configuration is adopted in which an absolute acceleration calculated based on detection results by the sensors is adjusted by using the direction error estimate value.

A configuration is adopted in which, based on the adjusted absolute acceleration, azimuth data indicating the direction of travel of the user and coordinate data indicating the position are calculated.

By the above configurations, according to the inertial device 130 of the present embodiment, it becomes possible to adjust the absolute acceleration every time the user walks on the corridors which serve as the reference directions (that is, frequently).

That is, the azimuth data calculated by the inertial device 130 according to the present embodiment is calculated by using the absolute acceleration that is adjusted frequently, and thereby it becomes possible to avoid the decreased calculation accuracy due to the time passage. As a result, it becomes possible to increase the calculation accuracy of the azimuth data.

### Second Embodiment

In the first embodiment described above, as sensors for indicating the movement state of the user, the acceleration sensor 405, the angular velocity sensor 406, and the geomagnetic sensor 407 are configured to be used, but the present invention is not limited to this configuration. For example, another sensor may be used as long as it is built in the inertial device 130 and it can detect a signal indicating the movement state of the user.

Also, in the first embodiment described above, as a straight line walking condition of the direction adjusting condition information 440, “15 m straight line walk” is configured to be defined, but the present invention is not limited to this configuration, and a longer distance (or a shorter distance) may be defined based on the map information of the building including an office where the user exists.

Also, in the first embodiment described above, the straight line walking condition is configured to be defined with respect to a predetermined distance (length), but the present invention is not limited to this configuration. For example, the straight line walking condition may be configured to be defined with respect to a predetermined time, a predetermined number of points of coordinate data, a predetermined number of walking steps, or the like.

Also, in the first embodiment described above, in order to specify the movement direction, an approximate straight line calculation using a least square method is configured to be used, but the present invention is not limited to this configuration, and other configuration may be adopted in which the approximate straight line is calculated by using other methods.

Also, in the first embodiment described above, when attitude information is calculated in the attitude calculation unit 1414, a configuration is adopted in which detected results of the sensors obtained by the acceleration obtaining unit 1411, the angular velocity obtaining unit 1412 and the geomagnetic obtaining unit 1413 are used, but the present invention is not limited to this configuration. For example, in the case where the reliability of the detection result of the geomagnetic sensor 401 obtained by the geomagnetic obtaining unit 1413 is decreased, the detection results of the sensors obtained by only the acceleration obtaining unit 1411 and the angular velocity obtaining unit 1412 may be configured to be used.

Also, in the first embodiment described above, a configuration is adopted in which the direction error estimate value based on the absolute acceleration calculated this time is used for adjusting the absolute acceleration calculated in the next time, but the present invention is not limited to this configuration. A configuration may be adopted in which the direction error estimate value based on the absolute acceleration calculated this time is used for adjusting the absolute acceleration calculated during a predetermined period in the. past. Also, a configuration may be adopted in which it is determined whether the direction error estimate value based on the absolute acceleration calculated this time is used for adjusting the absolute acceleration calculated during a predetermined period in the past or not according to the reliability of the calculated direction error estimate value.

It should be noted that the present invention is not limited to the configurations described in the above embodiments and configurations combined with other elements, or the like may be adopted. Regarding the embodiments described above, modifications may be possible without departing from the spirit of the present invention and may be defined accordingly depending on applications.

The present application is based on Japanese Priority Application No. 2014-029490 filed on Feb. 19, 2014 with the Japanese Patent Office, the entire contents of which are hereby incorporated by reference.

### DESCRIPTION OF THE REFERENCE NUMERALS

100: Positioning system
110: Positioning server apparatus
120: Access point
130: Inertial device
410: Positioning unit
420: Azimuth data
430: Coordinate data
440: Direction adjusting condition information
510: Direction of travel estimation unit
520: Position estimation unit
530: Azimuth drift estimation processing unit
531: Moving state detection unit
532: Azimuth drift calculation unit
540: Attitude information conversion processing unit
1000: Approximate straight line
1100: Line indicating the reference direction −90 degrees

### RELATED ART DOCUMENT

Patent document 1: WO2010/001970

1. An inertial device for, by using azimuth data indicating a direction of travel calculated based on an acceleration of a moving user, calculating coordinate data indicating a position of the user, the inertial device comprising:
a determination unit configured to determine whether a moving direction, which is specified based on the coordinate data calculated while the user makes a predetermined amount of movement, of the predetermined amount of movement of the user satisfies a predetermined condition with respect to a predetermined reference direction; and
an adjusting unit configured to, in response to the determination by the determination unit that the predetermined condition is satisfied, adjust the acceleration, which is newly obtained to calculate new coordinate data, based on a difference between the direction of travel indicated by the azimuth data which have already been calculated and the reference direction.

2. The inertial device according to claim 1,
wherein the determination unit determines whether the moving direction of the predetermined amount of movement of the user specified based on any of
the coordinate data calculated while the user makes a movement of a predetermined time,
the coordinate data calculated while the user makes a movement of a predetermined distance,
the coordinate data calculated while the user makes a movement of a predetermined number of steps, and
the coordinate data of a predetermined number of points satisfies the predetermined condition with respect to the predetermined reference direction.

3. The inertial device according to claim 1, wherein the determination unit determines, by calculating an approximate straight line based on the coordinate data calculated while the user makes the predetermined amount of movement, the moving direction of the predetermined amount of movement of the user.

4. The inertial device according to claim 1,
wherein the determination unit determines that the predetermined condition is satisfied in a case where an angular difference between the moving direction of the predetermined amount of movement of the user and the reference direction is equal to or less than a predetermined angular difference.

5. The inertial device according to claim 1,
wherein the adjusting unit adjusts the acceleration so that a difference between the direction of travel and the reference direction becomes smaller.

6. A control method of an inertial device for, by using azimuth data indicating a direction of travel calculated based on an acceleration of a moving user, calculating coordinate data indicating a position of the user, the control method comprising:
determining whether a moving direction, which is specified based on the coordinate data calculated while the user makes a predetermined amount of movement, of the predetermined amount of movement of the user satisfies a predetermined condition with respect to a predetermined reference direction; and
adjusting step-of, in response to the determination in the determining that the predetermined condition is satisfied, the acceleration, which is newly obtained to calculate new coordinate data, based on a difference between the direction of travel indicated by the azimuth data which have already been calculated and the reference direction.

7. A non-transitory computer-readable storage medium storing a program for causing a computer of an inertial device for, by using azimuth data indicating a direction of travel calculated based on an acceleration of a moving user, calculating coordinate data indicating a position of the user, to execute a method, the method comprising:
determining whether a moving direction, which is specified based on the coordinate data calculated while the user makes a predetermined amount of movement, of the predetermined amount of movement of the user satisfies a predetermined condition with respect to a predetermined reference direction; and
adjusting step-of, in response to determination in the determining that the predetermined condition is satisfied, the acceleration, which is newly obtained to calculate new coordinate data, based on a difference between the direction of travel indicated by the azimuth data which have already been calculated and the reference direction.
